(19) United States
(12) Patent Application Publication
(10) Pub. No.: US 2015/0352765 A1
(43) Pub. Date: Dec. 10, 2015

(54) METHOD FOR LOW-STRESS INJECTION MOULDING OF AMORPHOUS OR MICROCRYSTALLINE POLYAMIDES AND ALSO CORRESPONDINGLY PRODUCED LOW-STRESS POLYAMIDE MOULDED ARTICLES

(71) Applicant: EMS-PATENT AG, Domat/Ems (CH)

(72) Inventors: Botho HOFFMANN, Domat/Ems (CH); Alexander LAMPE, Domat/Ems (CH)

(73) Assignee: EMS-PATENT AG, Domat/Ems (CH)

(21) Appl. No.: 14/729,277

(22) Filed: Jun. 3, 2015

(30) Foreign Application Priority Data
Jun. 6, 2014 (EP) 14 171 526.8

(51) Int. Cl. B29C 45/77; B29C 45/78; C08J 5/00

(52) U.S. Cl. CPC B29C 45/77; C08J 5/00; B29C 45/78; C08J 2377/06; C08J 2377/02; B29K 2077/00

(57) ABSTRACT

The present invention relates to a method for low-stress injection moulding of amorphous or microcrystalline polyamides, in which a melt of the amorphous or microcrystalline polyamides is processed and injection moulded under specific conditions. Hence, low-stress moulded articles made of the amorphous or microcrystalline polyamides can be produced by injection moulding. The present invention relates in addition to the correspondingly produced moulded articles.

The present invention relates to a method for low-stress injection moulding of amorphous or microcrystalline polyamides, in which a melt of the amorphous or microcrystalline polyamides is processed and injection moulded under specific conditions. Hence, low-stress moulded articles made of the amorphous or microcrystalline polyamides can be produced by injection moulding. The present invention relates in addition to the correspondingly produced moulded articles.

Methods for injection moulding of amorphous or microcrystalline polyamide moulding compounds are known from the state of the art. For example, it is known from EP 1 369 447 A1 to process amorphous or microcrystalline polyamides, such as for example PA MACM12 or PA MACM12/PACM12, with different ratios of MACM to PACM by means of injection moulding.

Corresponding possibilities for processing amorphous polyamides are likewise known from EP 1 397 414 A1, EP 1 979 396 A1 and also EP 2 055 743 A1.

During the injection-moulding method, generally the temperature of the moulding compound to be injected and the mould temperature are prescribed. In addition, parameters such as, e.g. injection pressure, injection speed, dynamic pressure or dwell pressure can be varied. However, it has to date not been recognised that coordination of these parameters to each other might have effects on the properties of the injection-moulded article. In particular, it is still problematic that, in the case of moulded articles produced from amorphous or microcrystalline moulding compounds by injection moulding, low stress-cracking resistance can be observed.

The object of the present invention was therefore to indicate an injection-moulding method for amorphous or microcrystalline polyamides, with which the stress-cracking resistance in the produced moulded articles can be noticeably improved.

This object is achieved by the method according to patent claim 1. A correspondingly produced moulded article is described with patent claim 15. The respectively dependent patent claims thereby represent advantageous developments.

Hence, the present invention relates to a method for low-stress injection moulding of amorphous or microcrystalline polyamides, in which a polyamide melt, consisting of an amorphous or microcrystalline polyamide or a mixture of at least two amorphous or microcrystalline polyamides, is injection moulded by means of an injection mould, the polyamide melt being adjusted, during the injection-moulding process, to a temperature of 255 to 310° C., the temperature of the injection mould being adjusted to 50 to 120° C. and the injection speed of the polyamide melt being adjusted to 10 to 50 mm/s.

Surprisingly, it was established that a combination of three special parameters of the injection-moulding method, namely adjustment of the polyamide melt and also of the injection mould to specific temperatures, combined with the injection speed of the polyamide melt, leads to significantly improved values in the stress-cracking resistance in the produced moulded articles. It is thereby essential to coordinate these three parameters to the ranges indicated in claim 1. Only with this are the advantages according to the invention achieved.

The amorphous or microcrystalline polyamides exhibit, in the dynamic differential scanning calorimetry (DSC) according to ISO 11357, a melt heat of at most 30 J/g, preferably of at most 25 J/g, particularly preferred 0 to 22 J/g, at a heating rate of 20 K/min.

Microcrystalline polyamides are partially crystalline polyamides and therefore exhibit a melting point.

The amorphous polyamides have, compared with the microcrystalline polyamides, an even lower melting heat. The amorphous polyamides exhibit, in dynamic differential scanning calorimetry (DSC) according to ISO 11357, a melting heat of at most 5 J/g, preferably of at most 3 J/g, particularly preferred of 0 to 1 J/g, at a heating rate of 20 K/min.

According to a preferred embodiment, the injection speed of the polyamide melt during the injection-moulding process is adjusted to 15 to 35 mm/s, preferably 18 to 30 mm/s.

Preferred temperatures of the polyamide melt during the injection-moulding process are thereby from 260 to 295° C., preferably 270 to 290° C.

Advantageously, the temperature of the injection mould during the injection-moulding process is from 60 to 100° C., preferably 70 to 90° C.

In addition to the above-mentioned three essential parameters, the following values can also be adjusted for the remaining parameters during the injection-moulding process.

In particular, the injection pressure during the injection-moulding process is adjusted to 800 to 1,500 bar, preferably 900 to 1,400 bar, particularly preferred 1,000 to 1,300 bar.

During the injection-moulding process, it is likewise preferred to adjust the dynamic pressure to 50 to 200 bar, preferably 70 to 150 bar, particularly preferred 100 to 130 bar.

Additionally or alternatively hereto, the dwell pressure can be adjusted to 400 to 800 bar, preferably 500 to 700 bar, particularly preferred 550 to 650 bar, during the injection-moulding process.

The injection-moulding process is thereby implemented in particular on a conventional injection-moulding machine. This has a screw for transport of the polyamide melt. This preferably concerns hereby a current 3-zone standard screw with 20 to 40 mm diameter. In particular, the screw circumferential speed of the conveying screw is thereby adjusted to 0.20 to 0.50 m/s, preferably 0.25 to 0.42 m/s, particularly preferred 0.28 to 0.35 m/s.

Preferably, the dwell time of the polyamide melt in the cylinder of the injection-moulding machine is 0.5 to 6 min, preferably 0.75 to 5 min, particularly preferred 1 to 3 min.

With respect to the amorphous or microcrystalline polyamides, the present invention is not subject to any restriction. Preferably, the amorphous or microcrystalline polyamide is thereby selected from the group consisting of amorphous or microcrystalline polyamides with a glass transition temperature (measured according to ISO 11357) of 125 to 210° C., preferably of 145 to 200° C., particularly preferred of 150 to 190° C.

In particular, the amorphous or microcrystalline polyamide is formed from at least one diamine, selected from a group which consists of ethylenediamine, butanediamine, pentanediamine, methylpentanediamine, hexamethylenediamine, octanediamine, methyloctanediamine, nonanediamine, decanediamine, undecanediamine, dodecanediamine, trimethylhexamthylenediamine, bis(aminocyclohexyl)methane and its alkyl derivatives, bis(aminocyclohexyl)propane and its alkyl derivatives, isophoronediamine, norbornanediamine, bis(aminomethyl)norbornane, xylylenediamine, cyclohexanediamine, bis(aminomethyl)cyclohexane and its alkyl derivatives, and at least one dicarboxylic acid, selected from a group which consists of succinic acid, glutaric acid, adipic acid, pimelic acid, suberic acid, azeleic acid, sebacic acid, undecanedioic acid, dodecanedioic acid, brassylic acid, tetradecanedioic acid, pentadecanedioic acid, hexadecanedioic acid, heptadecanedioic acid, octadecanedioic acid, nonadecanedioic acid, eicosanedioic acid, japanic acid, cyclohexane dicarboxylic acid, phenylindane dicarboxylic acid, phenylenedioxydiacetic acid, dimer fatty acid with 36 or 44 C atoms, isophthalic acid, terephthalic acid, naphthalene dicarboxylic acid, and possibly at least one lactam with 4 to 15 C atoms and/or α,ω-amino acid with 4 to 15 C atoms.

Specially preferred diamines are hexamethylenediamine, trimethylhexamethylenediamine, 2-methyl-1,5-pentanediamine, bis(4-amino-3-methylcyclohexyl)methane (abb. MACM), bis(4-aminocyclohexyl)methane (abb. PALM), bis(4-amino-3-ethylcyclohexyl)methane, bis(4-amino-3,5-dimethylcyclohexyl)methane (abb. TMDC), 2,2-(4,4′-diaminodicyclohexyl)propane, isophoronediamine, norbornanediamine, m-xylylenediamine (abb. MXD) and 1,3-bis(aminomethyl)cyclohexane (abb. 1,3-BAC).

Specially preferred dicarboxylic acids are adipic acid, azeleic acid, sebacic acid, 1,12-dodecanedioic acid, brassylic acid, 1,14-tetradecanedioic acid, 1,15-pentadecanedioic acid, 1,16-hexadecanedioic acid, 1,18-octadecanedioic acid, 1,3-cyclohexane dicarboxylic acid, 1,4-cyclohexane dicarboxylic acid, phenylindane dicarboxylic acid, 1,4-phenylenedioxydiacetic acid, 1,3-phenylenedioxydiacetic acid, dimer fatty acid with 36 or 44 C atoms, isophthalic acid (abb. I), terephthalic acid (abb. T) and 2,6-naphthalene dicarboxylic acid (abb. N).

Specially preferred lactams are lactams or α,ω-amino acids with 4, 6, 7, 8, 11 or 12 C atoms. These are the lactams pyrrolidin-2-one (4 C atoms), ε-caprolactam (6 C atoms), oenanthlactam (7 C atoms), capryllactam (8 C atoms), laurinlactam (12 C atoms) or the α,ω-amino acids 1,4-aminobutanoic acid, 1,6-aminohexanoic acid, 1,7-aminoheptanoic acid, 1,8-aminooctanoic acid, 1,11-aminoundecanoic acid and 1,12-aminododecanoic acid.

In particular, it is preferred if the amorphous or microcrystalline polyamides are selected from the group consisting of PA 6I, PA 6I/6T, PA6I/6T/6N, PA MXDI/6I, PA MXDI/MXDT/6I/6T, PA MXDI/12I, PA MXDI, PA, MXDI/MXD6, PA MACM10, PA MACM12, PA MACM14, PA MACM18, PA NDT/INDT, PA TMDC10, PA TMDC12, PA TMDC14, PA TMDC18, PA PACM12, PA PACM10/11, PA PACM10/12, PA MACMI/12, PA MACMT/12, PA MACMI/MACM12, PA MACMI/MACMN, PA MACMT/MACM12, PA MACMT/MACMN, PA MACM36, PA TMDC36, PA MACMI/MACM36, PA 6I/MACMI/12, PA MACMT/MACM36, PA MACMI/MACMT/12, PA 6I/6T/MACMI/MACMT, PA 6I/6T/MACMI/MACMT/12, PA MACM6/11, PA MACM6/12, PA MACM10/11, PA MACM10/12, PA MACM10/1010, PA MACM12/1012, PA MACM14/1014, PA MACM18/1018, PA MACM12/1212, PA 6I/6T MACMI/MACMT/MACM12/612, PA 6I/6T/MACMI/MACMT/MACM12, PA MACMI/MACMT/MACM12/12, PA MACMI/MACMT/MACM12, PA 6I/6T/MACMI/MACMT/12, PA 6I/6T/6N/MACMI/MACMT/MACMN and mixtures or copolymers hereof, the MACM being able to be replaced up to at most 25% by mol, relative to the sum of the molar proportions of all the monomers of 100% by mol, by PACM and/or the laurinlactam entirely or partially by caprolactam.

With respect to the quantity of naphthalene dicarboxylic acid, a quantity of at most 10% by mol, relative to the sum of the molar proportions of all the monomers of 100% by mol, is preferred.

The content of lactam and/or α,ω-amino acid of the amorphous or microcrystalline polyamide is 0 to 40% by mol, preferably 0 to 30% by mol, relative to the sum of the molar proportions of all the monomers of 100% by mol.

Particularly preferred amorphous polyamides are:

PA MXDI/6I, PA MXDI/MXD6, PA MACM10, PA MACM12, PA MACM12/PACM12, PA MACM14, PA MACM14/PACM14, PA MACM18, PA TMDC12, PA TMDC14, PA TMDC18, PA MACMI/12, PA MACMI/MACM12, PA MACMI/MACMT/12, PA 6I/6T/MACMI/MACMT, PA MACM10/1010, PA MACM14/1014, PA 6I/6T/MACMI/MACMT/MACM12, PA MACMI/MACMT/MACM12/12, PA MACMI/MACMT/MACM12, PA 6I/6T/MACMI/MACMT/PACMI/PACMT/12, PA 6I/6T/MACMI/MACMT/MACM12/PACMI/PACMT/PACM12 and mixtures or copolymers hereof, the content of PACM being at most 25% by mol, relative to the sum of the molar proportions of all the monomers of 100% by mol.

The proportion of the PACM in the PA MACM12/PACM12 is preferably 1 to 25% by mol, the sum of the molar proportions of all the monomers producing 100% by mol. PA MACM12/PACM12 with at most 25% by mol of PACM are amorphous.

The proportion of the PACM in the PA MACM14/PACM14 is preferably 1 to 25% by mol, the sum of the molar proportions of all the monomers producing 100% by mol. PA MACM14/PACM14 with at most 25% by mol of PACM are amorphous.

Amongst the PA MACMI/12, those with a proportion of laurinlactam of 15 to 50% by mol are preferred, the sum of the molar proportions of all the monomers producing 100% by mol. Particularly preferred are PA MACMI/12 with a proportion of laurinlactam of 20 to 40% by mol. Of particular preference are PA MACMI/12 with a proportion of laurinlactam of 19% by mol or 35% by mol.

Amongst the PA MACMI/MACMT/12, those with an equimolar ratio of isophthalic acid to terephthalic acid and a proportion of laurinlactam of 15 to 40% by mol are preferred, the sum of the molar proportions of all the monomers producing 100% by mol. For particular preference, the PA MACMI/MACMT/12 have an equimolar ratio of isophthalic acid to terephthalic acid and a proportion of laurinlactam of 20 to 30% by mol. For particular preference, the PA MACMI/MACMT/12 has the molar ratio 38/38/24.

Amongst the PA 6I/6T/MACMI/MACMT/12, those with an equimolar ratio of isophthalic acid to terephthalic acid and a proportion of laurinlactam of 1 to 25% by mol are preferred, the sum of the molar proportions of all the monomers producing 100% by mol. For particular preference, the PA 6I/6T/MACMI/MACMT/12 have an equimolar ratio of isophthalic acid to terephthalic acid and a proportion of laurinlactam of 2 to 15% by mol. For particular preference, the PA 6I/6T/MACMI/MACMT/12 has the molar ratio 34/34/14/14/4.

Amongst the PA 6I/6T/MACMI/MACMT/PACMI/PACMT/12, those with an equimolar ratio of isophthalic acid to terephthalic acid and a proportion of laurinlactam of 1 to 25% by mol are preferred, the sum of the molar proportions of all the monomers producing 100% by mol. For particular preference, the PA 6I/6T/MACMI/MACMT/PACMI/PACMT/12 have an equimolar ratio of isophthalic acid to terephthalic acid and a proportion of laurinlactam of to 15% by mol. For particular preference, the PA 6I/6T/MACMI/MACMT/PACMI/PACMT/12 have an equimolar ratio of isophthalic acid to terephthalic acid, a proportion of PACM of 2 to 7% by mol and a proportion of laurinlactam of 2 to 7% by mol.

Amongst the PA MACMI/MACMT/MACM/12, those with an equimolar ratio of isophthalic acid to terephthalic acid and a proportion of dodecanedioic acid of 30 to 60% by mol are preferred, the sum of the molar proportions of all the monomers producing 100% by mol. For particular preference, the PA MACMI/MACMT/MACM/12 have an equimolar ratio of isophthalic acid to terephthalic and a proportion of dodecanedioic acid of 40 to 50% by mol. For particular preference, the PA MACMI/MACMT/MACM/12 has the molar ratio 27/27/46.

If the polyamides comprise only diacids and diamines, then their molar proportions add up to 50% by mol for the sum of all diamines and 50% by mol for the sum of all diacids and the sum of the diamine- and diacid proportions produces 100% by mol for the polyamide.

If the polyamides comprise, in addition to diacids and diamines, also lactams or α,ω-amino acids at x % by mol, then the sum of all the diamines is only (50−0.5 x) % by mol and the sum of all the diacids (50−0.5 x) % by mol, relative to 100% by mol of polyamide.

In the case of the quantity data relating to the diacids and diamines of the polyamides, it always applies that the sum of the molar proportions of all the diamines is equal to the sum of the molar proportions of all the diacids.

The quantity data with respect to the monomers should thereby be understood such that also a corresponding molar ratio of these monomers used during polycondensation is found again in the polyamides produced in this way by polycondensation.

The amorphous or microcrystalline polyamides or the mixtures of amorphous or microcrystalline and partially crystalline aliphatic polyamides exhibit a light transmission, measured according to ASTM D 1003 on sheets of 2 mm thickness (produced in a high gloss mould whilst maintaining the injection-moulding parameters mentioned in this application), of at least 80%, preferably of at least 85%, particularly preferred of at least 88% and also very particularly preferred of at least 90%, and hence high transparency.

Partially crystalline polyamides can be used as mixture component for the amorphous or microcrystalline polyamides.

In the mixtures of amorphous or microcrystalline and partially crystalline aliphatic polyamides, 2 to 28% by weight, preferably 3 to 25% by weight, particularly preferred 10 to 20% by weight, of the amorphous or microcrystalline polyamide is replaced by at least one partially crystalline polyamide.

The preferred, partially crystalline aliphatic polyamides are selected from the group PA 6, PA 46, PA 49, PA 410, PA 411, PA 412, PA 413, PA 414, PA 415, PA 416, PA 418, PA 436, PA 66, PA 69, PA 610, PA 611, PA 612, PA 613, PA 614, PA 615, PA 616, PA 617, PA 618, PA 1010, PA 66/6, PA 6/66/12, PA 6/12, PA 11, PA 12, PA 912, PA 1212, PA MXD6, PA MXD9, PA MXD10, PA MXD11, PA MXD12, PA MXD13, PA MXD14, PA MXD15, PA MXD16, PA MXD17, PA MXD18, PA MXD36, PA PACM9, PA PACM10, PA PACM11, PA PACM12, PA PACM13, PA PACM14, PA PACM15, PA PACM16, PA PACM17, PA PACM18, PA PACM36, polyether amides, polyether ester amides, polyester amides and the mixtures or copolymers thereof.

For particular preference, the partially crystalline aliphatic polyamides are selected from the group PA 6, PA 69, PA 610, PA 612, PA 614, PA 1010, PA 1212, PA 6/66/12, PA 6/66, PA 6/12, PA 11, PA/12, polyether amides and polyether ester amides.

However, it is likewise particularly preferred if the melt processed in the injection-moulding method consists exclusively of an amorphous polyamide or a mixture or blend of a plurality of amorphous polyamides.

The spelling and abbreviations for polyamides and the monomers thereof are specified in the ISO standard 1874-1:1992(E).

The relative viscosity (RV) of the amorphous polyamides is preferably 1.35 to 2.15, preferably 1.40 to 1.85, particularly preferred 1.45 to 1.75, measured with 0.5 g in 100 ml m-cresol at 20° C.

The relative viscosity (RV) of the partially crystalline aliphatic polyamides is preferably 1.40 to 2.15, preferably 1.45 to 2.0, particularly preferred 1.50 to 1.90, measured with 0.5 g in 100 ml m-cresol at 20° C.

The amorphous or microcrystalline polyamides or the mixtures of amorphous or microcrystalline and partially crystalline aliphatic polyamides can in addition comprise further additives, in particular selected from the group consisting of condensation catalysts, chain regulators, defoamers, inorganic stabilisers, organic stabilisers, lubricants, colourants, marking agents, pigments, colourants, nucleation agents, crystallisation inhibitors, antistatic agents, mould-release agents, optical brighteners, natural layer silicates, synthetic layer silicates and mixtures thereof.

As stabilisers or age-protecting agents, for example antioxidants, antiozonants, light-protecting agents, UV stabilisers, UV absorbers or UV blockers can be used in the amorphous or microcrystalline polyamides.

The further additives can preferably be contained in a quantity of 0.01 to 6% by weight, relative to the total polyamide moulding compound.

In addition, the present invention likewise relates to a moulded article which can be produced according to the preceding method. The moulded article is thereby formed from an amorphous or microcrystalline polyamide or a mixture of at least two amorphous or microcrystalline polyamides. The moulded article according to the invention is distinguished by increased stress-cracking resistance, compared with moulded articles made of an amorphous or microcrystalline polyamide or a mixture of at least two amorphous or microcrystalline polyamides which are not produced according to the above-described method. Preferably, measurement of the stress-cracking resistance is thereby implemented in isopropanol or pyrrolidone.

The present invention is explained in more detail with reference to the subsequent examples without restricting the invention to the illustrated special parameters.

For examining the influence of the various parameters of the injection-moulding method, in particular the compound temperature, mould temperature, injection speed, injection pressure, dynamic pressure, dwell pressure and screw circumferential speed, on the stress-cracking resistance of a moulded article produced by a corresponding injection-moulding method, the subsequent injection-moulding experiments were implemented with different amorphous polyamides.

As moulded article, the ISO test piece, standard: ISO/CD 3167, type A1, 170×20/10×4 mm was chosen.

The ISO test pieces were produced on an injection-moulding machine of the company Arburg, Modell Allrounder 420 C 1000-250 with a 3-zone standard screw with a diameter of 25 mm. The injection-moulding parameters indicated in Table 2 were used.

The ISO test pieces were used in the dry state; for this purpose, they were stored, after the injection moulding, for at least 48 h at room temperature in a dry environment, i.e. over silica gel.

Measuring Methods Used in this Application:

### Modulus of Elasticity in Tension:

ISO 527 with a tensile speed of 1 mm/min
ISO test piece, standard: ISO/CD 3167, type A1, 170×20/10×4 mm, temperature 23° C.

### Relative Viscosity

ISO 307
Granulate
0.5 g in 100 ml m-cresol
Temperature 20° C.
Calculation of the relative viscosity (RV) according to RV=t/t₀ following section 11 of the standard.

### Melting Point, Melting Heat and Glass Transition Temperature (Tg):

ISO 11357
Granulate
Differential scanning calorimetry (DSC) was implemented at a heating rate of 20 K/min. At the melting point, the temperature is indicated at the peak maximum. The centre of the glass transition range which is indicated as glass transition temperature (Tg) was determined according to the “half height” method.

### Stress-Cracking Resistance:

DIN 53449, part 3 bending strip method
ISO test piece, standard: ISO/CD 3167, type A1, 170×20/10×4 mm, temperature 23° C.
The outer fibre strain is measured, at which, after 60 second immersion of the ISO test piece, which is under stress, into the solvent, cracks are visible with the naked eye.
For conversion of the measured outer fibre strain into the indicated stress, the obtained percentage value of the outer fibre strain is multiplied by the modulus of elasticity in tension (dry, MPa) of the measured material.

### Light Transmission

ASTM D 1003
Sheet, thickness 2 mm, 60×60 mm
Temperature 23° C.
Measuring device Haze Gard plus of the company Byk Gardner with CIE light type C. The light transmission value is indicated in % of the irradiated quantity of light.

In Table 1, the materials used in the examples and comparative examples are indicated:

TABLE 1

| Material | Description | Manufacturer |
|---|---|---|
| polyamide A1 | amorphous polyamide MACM12 made of bis(3-methyl-4- | EMS-CHEMIE AG, |
| | aminocyclohexyl)methane and dodecanedioic acid | Switzerland |
| | RV 1.70 (measured with 0.5 g in 100 ml m-cresol at | |
| | 20° C.) | |
| | glass transition temperature 155° C. | |
| | modulus of elasticity in tension, dry, at 23° C. 1,600 MPa | |
| polyamide A2 | amorphous polyamide MACMI/MACMT/12 in the molar | EMS-CHEMIE AG, |
| | ratio 38/38/24 made of | Switzerland |
| | bis(3-methyl-4-aminocyclohexyl)methane, isophthalic | |
| | acid, terephthalic acid and laurinlactam | |
| | RV 1.53 (measured with 0.5 g in 100 ml m-cresol at 20° C.) | |
| | glass transition temperature 190° C. | |
| | modulus of elasticity in tension, dry, at 23° C. 2,200 MPa | |
| polyamide A3 | amorphous polyamide MACMI/MACMT/MACM12 in the | EMS-CHEMIE AG, |
| | molar ratio 27/27/46 made of bis(3-methyl-4- | Switzerland |
| | aminocyclohexyl)methane, isophthalic acid, terephthalic | |
| | acid and dodecanedioic acid | |
| | RV 1.54 (measured with 0.5 g in 100 ml m-cresol at 20° C.) | |
| | glass transition temperature 200° C. | |
| | modulus of elasticity in tension, dry, at 23° C. 2,100 MPa | |

In order to determine the stress input during injection moulding, the ISO test pieces made of the different amorphous polyamides described in Table 1 were produced by means of injection moulding. The individual parameters for the respective injection moulding method are indicated in Table 2. The stress-cracking resistance was measured in two different solvents. Surprisingly, it was able to be established that the stress-cracking resistance (measured for example in isopropanol or pyrrolidone), in the case of the ISO test pieces produced according to the invention, in which exact coordination of the compound temperature, mould temperature and injection speed was effected, turns out to be significantly higher than in the case of the comparative examples in which different parameters are used for the injection moulding method.

TABLE 2
examples and comparative examples

| Injection moulding | | Examples | | | Comparative examples | | | |
|---|---|---|---|---|---|---|---|---|
| parameters | Unit | 1 | 2 | 3 | 4 | 5 | 6 | 7 |
| polyamide | — | A1 | A2 | A3 | A1 | A1 | A2 | A3 |
| compound | ° C. | 275 | 290 | 290 | 255 | 265 | 290 | 290 |
| temperature | | | | | | | | |
| mould temperature | ° C. | 70 | 90 | 90 | 50 | 60 | 90 | 90 |
| injection pressure | bar | 1,000 | 1,300 | 1,300 | 1,500 | 1,000 | 1,300 | 1,300 |
| injection speed | mm/s | 20 | 20 | 20 | 60 | 90 | 90 | 90 |
| dynamic pressure | bar | 120 | 120 | 120 | 50 | 120 | 120 | 120 |
| dwell pressure | bar | 600 | 600 | 600 | 1,000 | 1,000 | 1,100 | 1,100 |
| screw | m/s | 0.30 | 0.30 | 0.30 | 0.40 | 0.30 | 0.30 | 0.30 |
| circumferential | | | | | | | | |
| speed | | | | | | | | |
| tests | — | | | | | | | |
| stress-cracking | | | | | | | | |
| resistance | | | | | | | | |
| isopropanol | MPa | 12 | 22 | 17 | 0 | 0 | 17 | 5 |
| pyrrolidone | MPa | 20 | 11 | 21 | 16 | 16 | 0 | 10 |

1. A method for low-stress injection moulding of amorphous or microcrystalline polyamides, in which a polyamide melt, consisting of an amorphous or microcrystalline polyamide or a mixture of at least two amorphous or microcrystalline polyamides, is injection moulded by means of an injection mould, during the injection-moulding process,
the polyamide melt being adjusted to a temperature of 255 to 310° C.,
the temperature of the injection mould being adjusted to 50 to 120° C. and
the injection speed of the polyamide melt being adjusted to 10 to 50 mm/s.

2. The method according to claim 1, wherein, during the injection-moulding process, the injection speed of the polyamide melt is adjusted to 15 to 35 mm/s.

3. The method according to claim 1, wherein, during the injection-moulding process, the polyamide melt is adjusted to a temperature of 260 to 295° C.

4. The method according to claim 1, wherein, during the injection-moulding process, the temperature of the injection mould is adjusted to 60 to 100° C.

5. The method according to claim 1, wherein, during the injection-moulding process, the injection pressure is adjusted to 800 to 1,500 bar.

6. The method according to claim 1, wherein, during the injection-moulding process, the dynamic pressure is adjusted to 50 to 200 bar.

7. The method according to claim 1, wherein, during the injection-moulding process, the dwell pressure is adjusted to 400 to 800 bar.

8. The method according to claim 1, wherein, during the injection-moulding process, the screw circumferential speed is adjusted to 0.20 to 0.50 m/s.

9. The method according to claim 1, wherein the dwell time of the polyamide melt in the cylinder of the injection-moulding machine is adjusted to 0.5 to 6 min.

10. The method according to claim 1, wherein the amorphous or microcrystalline polyamide is selected from the group consisting of amorphous or microcrystalline polyamides with a glass transition temperature (measured according to ISO 11357) of 125 to 210° C.

11. The method according to claim 1, wherein the amorphous or microcrystalline polyamide is formed from
at least one diamine, selected from a group which consists of ethylenediamine, butanediamine, pentanediamine, methylpentanediamine, hexamethylenediamine, octanediamine, methyloctanediamine, nonanediamine, decanediamine, undecanediamine, dodecanediamine, trimethylhexamethylene diamine, bis(aminocyclohexyl)methane and its alkyl derivatives, bis(aminocyclohexyl)propane and its alkyl derivatives, isophoronediamine, norbornanediamine, bis(aminomethyl)norbornane, xylylenediamine, cyclohexanediamine, bis(aminomethyl)cyclohexane and its alkyl derivatives, and
at least one dicarboxylic acid, selected from a group which consists of succinic acid, glutaric acid, adipic acid, pimelic acid, suberic acid, azeleic acid, sebacic acid, undecanedioic acid, dodecanedioic acid, brassylic acid, tetradecanedioic acid, pentadecanedioic acid, hexadecanedioic acid, heptadecanedioic acid, octadecanedioic acid, nonadecanedioic acid, eicosanedioic acid, japanic acid, cyclohexane dicarboxylic acid, phenylindane dicarboxylic acid, phenylenedioxydiacetic acid, dimer fatty acid with 36 or 44 C atoms, isophthalic acid, terephthalic acid, naphthalene dicarboxylic acid, and optionally
at least one lactam with 4 to 15 C atoms and/or α,ω-amino acid with 4 to 15 C atoms.

12. The method according to claim 1, wherein the amorphous or microcrystalline polyamide is selected from the group consisting of PA 6I, PA 6I/6T, PA6I/6T/6N, PA MXDI/6I, PA MXDI/MXDT/6I/6T, PA MXDI/12I, PA MXDI, PA MXDI/MXD6, PA MACM10, PA MACM12, PA MACM14, PA MACM18, PA NDT/INDT, PA TMDC10, PA TMDC12, PA TMDC14, PA TMDC18, PA PACM12, PA PACM10/11, PA PACM 10/12, PA MACMI/12, PA MACMT/12, PA MACMI/MACM12, PA MACMI/MACMN, PA MACMT/MACM12, PA MACMT/MACMN, PA MACM36, PA TMDC36, PA MACMI/MACM36, PA 6I/MACMI/12, PA MACMT/MACM36, PA MACMI/MACMT/12, PA 6I/6T/MACMI/MACMT, PA 6I/6T/MACMI/MACMT/12, PA MACM6/11, PA MACM6/12, PA MACM10/11, PA MACM10/12, PA MACM10/1010, PA MACM12/1012, PA MACM14/1014, PA MACM18/1018, PA MACM12/1212, PA 6I/6T/MACMI/MACMT/MACM12/612, PA 6I/6T/MACMI/MACMT/MACM12, PA MACMI/MACMT/MACM12/12, PA MACMI/MACMT/MACM12, PA 6I/6T/MACMI/MACMT/12, PA 6I/6T/6N/MACMI/MACMT/MACMN and mixtures or copolymers thereof, the MACM being able to be replaced up to at most 25% by mol, relative to the sum of the molar proportions of all the monomers of 100% by mol, by PACM and/or the laurinlactam entirely or partially by caprolactam.

13. The method according to claim 1, wherein the amorphous or microcrystalline polyamide is replaced, up to 2 to 28% by weight, by at least one partially crystalline aliphatic polyamide, this at least one partially crystalline aliphatic polyamide being selected from the group consisting of PA 6, PA 46, PA 49, PA 410, PA 411, PA 412, PA 413, PA 414, PA 415, PA 416, PA 418, PA 436, PA 66, PA 69, PA 610, PA 611, PA 612, PA 613, PA 614, PA 615, PA 616, PA 617, PA 618, PA 1010, PA 66/6, PA 6/66/12, PA 6/12, PA 11, PA 12, PA 912, PA 1212, PA MXD6, PA MXD9, PA MXD10, PA MXD11, PA MXD12, PA MXD13, PA MXD14, PA MXD15, PA MXD16, PA MXD17, PA MXD18, PA MXD36, PA PACM9, PA PACM10, PA PACM11, PA PACM12, PA PACM13, PA PACM14, PA PACM15, PA PACM16, PA PACM17, PA PACM18, PA PACM36, PA PACM10/11, PA PACM10/12, polyether amides, polyether ester amides, polyester amides and mixtures or copolymers thereof, in particular PA 6, PA 69, PA 610, PA 612, PA 614, PA 1010, PA 1212, PA 6/66/12, PA 6/66, PA 6/12, PA 11, PA 12, polyether amides, polyether ester amides and mixtures or copolymers thereof.

14. The method according to claim 13, wherein the amorphous or microcrystalline polyamide is replaced, up to 5 to 25% by weight, by at least one partially crystalline aliphatic polyamide.

15. The method according to claim 14, wherein the amorphous or microcrystalline polyamide comprises further additives, selected from the group consisting of condensation catalysts, chain regulators, defoamers, inorganic stabilisers, organic stabilisers, lubricants, colourants, marking agents, pigments, colourants, nucleation agents, crystallisation inhibitors, antistatic agents, mould-release agents, optical brighteners, natural layer silicates, synthetic layer silicates and mixtures thereof.

16. A molded article made of an amorphous or microcrystalline polyamide or a mixture of at least two amorphous or microcrystalline polyamides, produced according to a method according to claim 1, which has an increased stress-cracking resistance, compared with moulded articles made of an amorphous or microcrystalline polyamide or a mixture of at least two amorphous or microcrystalline polyamides which are not produced according to the method according to claim 1.

17. The method according to claim 2, wherein, during the injection-moulding process, the injection speed of the polyamide melt is adjusted to 18 to 30 mm/s.

18. The method according to claim 3, wherein, during the injection-moulding process, the polyamide melt is adjusted to a temperature of 270 to 290° C.

19. The method according to claim 4, wherein, during the injection-moulding process, the temperature of the injection mould is adjusted to 70 to 90° C.

20. The method according to claim 5, wherein, during the injection-moulding process, the injection pressure is adjusted to 900 to 1,400 bar.
